(19) United States
(12) Patent Application Publication
(10) Pub. No.: US 2006/0067229 A1
(43) Pub. Date: Mar. 30, 2006

(54) Transmitting data in a wireless network

(75) Inventor: Frank Frederiksen, Klarup (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/047,643

(22) Filed: Feb. 2, 2005

(30) Foreign Application Priority Data
Sep. 29, 2004 (GB) GB 0421663.6

(51) Int. Cl. H04J 1/16

(52) U.S. Cl. 370/235

(57) ABSTRACT

This invention relates to a method for determining a transport block size for use in a data transmission comprising the steps of determining a desired code rate for transmission of the data, adjusting the transport block size if the desired code rate is associated with a reduced performance.

### FIELD OF THE INVENTION

The present invention relates to transmitting data in a wireless communications network.

### BACKGROUND OF THE INVENTION

Packets can be transmitted according to the HSDPA (High Speed Downlink Packet Access) protocol implemented in a 3GPP (third generation partnership project) wideband code division multiple access (WCDMA) mobile telecommunications network.

High speed downlink packet access is a concept within WCDMA specifications whose main target is to increase user peak data rates and quality of service and to generally improve spectral efficiency for downlink asymmetrical and bursty packet data services. HSPDA has a short transmission time interval (TTI), adaptive modulation and coding (AMC), multi code transmission, fast physical layer (L1) hybrid automatic repeat request (H-ARQ) and uses a packet scheduler in a Node-B or base station where it has easy access to air interface measurements. HSPDA makes use of this by adjusting the user data rate to match the instantaneous radio channel conditions. While connected, an HSDPA user equipment periodically sends a channel quality indicator (CQI) to the Node-B or base transceiver station indicating what data rate the user equipment can support under its current radio conditions. The user equipment sends an acknowledgement for each packet so that the Node-B knows when to initiate retransmissions. With channel quality measurements available for each user equipment in the cell, the packet scheduler may optimise its scheduling amongst its users and thus divide the available capacity between them according to the running services and requirements.

Reference is made to Interdigital, “Turbo-coding and puncturing interactions on HS-DSCH (High speed downlink shared channel) in R5 HSDPA”, 3GPP document R1-030444. As mentioned, HSDPA supports link adaptation by means of AMC. The number of physical channels (multicodes), and the modulation scheme will determine the available transmission capacity on the physical medium, and the transport block size will give the source data rate. From these values, it is possible to calculate the effective code rate (ECR), but the ECR is not a parameter which the Node B sets or defines.

Rate matching will basically provide a matching (through repetition or puncturing) of the encoded transport block to the available capacity on the physical medium.

However it has been found that there are some problematic code rates which when used cause a significant degradation of the link level performance. In the Interdigital document, two solutions are suggested. One is to adjust the parity stream puncturing scheme. The other solution suggested is to avoid the problematic puncturing patterns. It is suggested that the puncturing patterns that lead to the degraded results should be avoided by using look up tables that identify the problematic configurations or by using an equation which identifies those problematic configurations. However, there is no further detail as to how this will be implemented in practise.

Reference is also made to Siemens, “Turbo coder irregularities in HSDPA” 3GPP document R1-030421. This document identifies the same problem. Again, it suggests two solutions. One solution is to disrupt the periodicity. For example, a mechanism is proposed to frequently switch between two coding rates during a rate matching process. The coding rates are chosen so that they are near to the problematic rate but themselves do not lead to performance degradation. The second proposal is to avoid the impacted code rate. Again, no detail is given as to how this can be achieved in practise.

It is an aim of embodiments of the present invention to provide a practical solution to the above mentioned problem.

### SUMMARY OF THE INVENTION

According to a first aspect in the present invention, there is provided a method for determining a transport block size for use in a data transmission comprising the steps of determining a desired code rate for transmission of the data, adjusting the transport block size if the desired code rate is associated with a reduced performance.

According to a second aspect of the present invention, there is provided apparatus for determining a transport block size for use in a data transmission comprising means for determining a desired code rate for transmission of the data and means for adjusting the transport block size if the desired code rate is associated with a reduced performance.

According to a third aspect of the present invention, there is provided an apparatus for determining a transport block size for use in a data transmission comprising circuitry adapted to determine a desired code rate for transmission of the data and at least one look up table for adjusting the transport block size if the desired code rate is associated with a reduced performance.

According to a fourth aspect of the present invention, there is provided a computer program medium having a program recorded thereon, wherein said program is to make the computer execute procedure to determine a desired code rate for transmission of the data and to adjust the transport block size if the desired code rate is associated with a reduced performance.

According to a fifth aspect of the present invention, there is provided A computer program element comprising program code means, wherein said program code means is to make a computer execute procedure to determine a desired code rate for transmission of the data and to adjust the transport block size if the desired code rate is associated with a reduced performance.

### BRIEF DESCRIPTION OF DRAWINGS

For a better understanding of the present invention and as to how the same may be carried into effect, reference will now be made by way of example to the accompanying drawings in which:

FIG. 1 shows a graph showing the problematic coding rates;

FIG. 2 shows a graph for QPSK (quadrature phase shift keying) with the effective code rate as a function of the transport block size index in embodiments of the present invention;

FIG. 3 shows the same plot as FIG. 2 but for 16-QAM (quadrature amplitude modulation);

FIG. 4 shows a schematic diagram of a cellular communication networks in which embodiments of the present invention can be implemented;

FIG. 5 shows a schematic block diagram of circuitry in a Node-B or base transceiver station in an embodiment of the present invention;

FIG. 6 shows a graph for QPSK (quadrature phase shift keying) with the effective code rate as a function of the number of physical channels allocated for transmission in embodiments of the present invention; and

FIG. 7 shows the same plot as FIG. 6 but for 16-QAM quadrature amplitude modulation).

### DETAILED DESCRIPTION OF PREFERRED EMBODIMENTS OF THE INVENTION

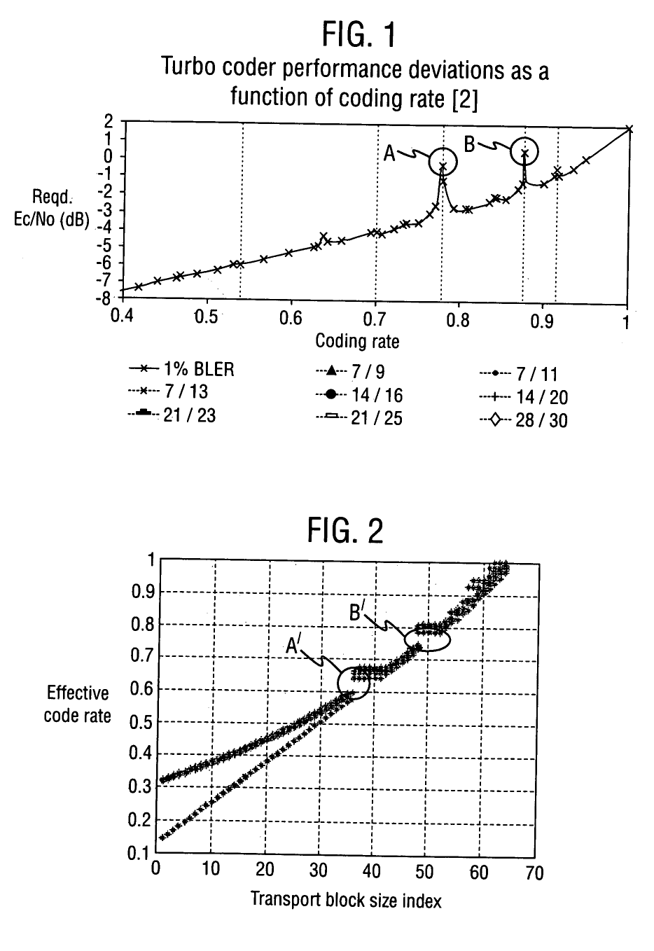

The problem which embodiments of the present invention address is illustrated in FIG. 1 which shows the turbo coder performance deviations as a function of coding rate. In particular, the Ec/NO (Ec is the signal energy in the data carrier, and NO is the “noise power spectral density”. The ratio between these is normally used as a metric for the SNR (signal to noise ratio)) for a 1% BLER (block error rate) is plotted as a function of the effective code rate. When increasing the effective coding rate or equivalently increasing the puncturing rate of a turbo coded transport block on HS-DSCH, it would be expected that the BLER performance would degrade proportionally i.e. getting increasingly worse (in terms of higher Ec/NO requirements) for increasingly higher coding rates. However as can be seen from FIG. 1 this does not occur at point A and B. Point A represents a rate of point 7/9 and point B represents a rate of 7/8. It should be appreciated that there are other problematic points but these two are generally regarded as being the worst and widest. It is understood that these points occur in that the periodicity in the output of two turbo coder parity bit streams interact with the periodicity of the puncturing patterns. This effect occurs more frequently as the puncturing rate increases.

It should be appreciated that whilst embodiments of the present invention are directed to dealing with the problem of poor performance at certain code rates, there are other criteria which need also to be addressed to find the correct transport block size to use for a transmission. It should be appreciated that transport block size will define the effective code rate.

The transport block size is derived from the Transport Format Resource Indicator TFRI. For retransmissions the Node B shall use the same transport block size as for the initial transmission. If this value cannot be signalled through the predefined values, a special signalling value is predefined to handle this case. This is defined in the 3GPP (Third Generation Partnership Project) Technical Specification TS 25.321 section 9.2.3.

The other criteria which needs to be taken into account is as follows:
1. The link adaptation has to find the effective code rate to use seen from a link quality point of view.
2. An integer number of MAC (media access control) PDUs (packet data units) and a MAC header have to fit into this effective code rate. If this can not be met 100%, a lower code rate can be chosen to ensure a higher probability that the packet comes through or a higher code rate can be chosen, thus relying more on H-ARQ to recover from the potential higher probability that there will be errors in the packet.
3. A transport block size has to be signalled on the HS-SCCH (high speed shared control channel). In some embodiments of the present invention, this can only take 63 values which are dependent on the number of codes and the modulation scheme.

It is possible to calculate the code rates where there is likely to be problems. This can be done using the following equation:

$$∃ \hat{N} ∈ \{ 1 , 2 , … \} s . t . \vert \frac{I}{( P / 2 )} - \frac{7 \hat{N}}{2} \vert < 1 - \frac{\hat{N}}{2} + ⌊ \frac{\hat{N}}{2} ⌋ ,$$

Where P is the total number of surviving parity bits at the output of rate matching (sum of Turbo-coded parity surviving bits from parity streams 1 and 2, I is the number of bits at the input to each branch of rate matching (transport block size), s is such, t is that, i.e st=such that.

This equation is only valid when the first stage rate matching is transparent, i.e., the UE has sufficient memory to store all the values after the rate de-matching.

A set of code rates that gives rise to problematic puncture patterns is a set of unconnected intervals of the real line, one interval per \hat{N}. Therefore only one such \hat{N} needs to be considered, the one that the minimises the left hand side of the previous equation that is:

$$\hat{N} = ⌊ \frac{4 I}{7 P} + \frac{1}{2} ⌋$$

Using the approached defined by these equations, it is possible to calculate the problematic situations for different values of P and I. However, in embodiments of the present invention, only transport block sizes that can actually be transmitted over the HS-SCCH are used.

Given a transport block size x that can be signalled over the HS-SCCH, it is possible to calculate the number of bits that come out of the turbo encoder:
(Y) Y=(x+CRC)+TAIL
where CRC (cyclic redundancy code) is the number of CRC bits (24) and TAIL is the number of tail bits from the turbo encoder (12). These values are fixed for the HS-DSCH but may in other applications of embodiments of the invention be different.

Using this information, the number of schematic bits out of the turbo encoder (I) is I=Y/3 and the total number of parity bits P as P=Z−I where Z is the number of bits available on the channel Z=2560/16*3*BPS, where BPS (bits per symbol) is 2 for QPSK and 4 for 16-QAM.

Whilst these equations are useful, they do not describe the situation fully (UE memory requirements), so in preferred embodiments of the invention the full functionality of the transmission chain is implemented, the performance of each legal/possible transport block size (TBS) has been evaluated, and a mapping function has be generated such that any TBS that causes poor performance will be re-mapped into a new TBS having better performance, but still offering the same fundamental data rate to the user (by changing the TBS, ECR is also changed, and thus the performance). In implementations of the present invention, the mapping tables are used to avoid the problematic transport block sizes.

However in alternative embodiments of the invention, the above equations may be used, to create a vector of possible signalled transport block sizes and to determine which of these should be avoided.

In one preferred embodiment of the present invention, the smallest transport block size, which will result in a higher code rate, but is not within the region to be avoided is selected.

Reference is made to FIG. 2 which shows the effect of code rate as a function of the transport block size index for QPSK. The transport size index is one that is found to be optimum for the transmission. This graph is for QPSK. As can be seen, there is a region A′ at around the effective code rate of 0.62 where there are various effective code rates which are not used. There is a second region B′ at around the effective code rate of 0.75 where again there is a discontinuity in the effective code rate. These coding rates are different from those shown in FIG. 1 and it is believed that the simulations shown in FIG. 2 represent ‘the reality’, whilst FIG. 1 is based on equations, which are based on some assumptions giving a simplified perspective.

The relation between the Transport block size TBS, TBS index and ECR is such that:

The TBS index can take a value between 0 and 62. Given the number of multicodes and the modulation scheme, it is possible to calculate the transport block size. This may be done using equations in 3GPP TS 25.321 as follows.

Let kᵢ be the TFRI signalled on the HS-SCCH value and let k_{0,i} be the value in a table corresponding to the modulation and the number of codes signalled on the HS-SCCH. Let kₜ be the sum of the two values: kₜ=kᵢ+k_{0,i}.

The transport block size L(kₜ) can be obtained by accessing the position kₜ in the a table or by using the formula below:
If kₜ<40
Error! Objects cannot be created from editing field codes.
else
Error! Objects cannot be created from editing field codes.

Now, given the number of multicodes and the modulation scheme, the capacity of the physical medium can be calculated, and the ratio between the TBS and the capacity is normally defined as the effective code rate.

It can be seen that the problematic regions about 0.62 and 0.75 are avoided by using slightly higher effective code rates.

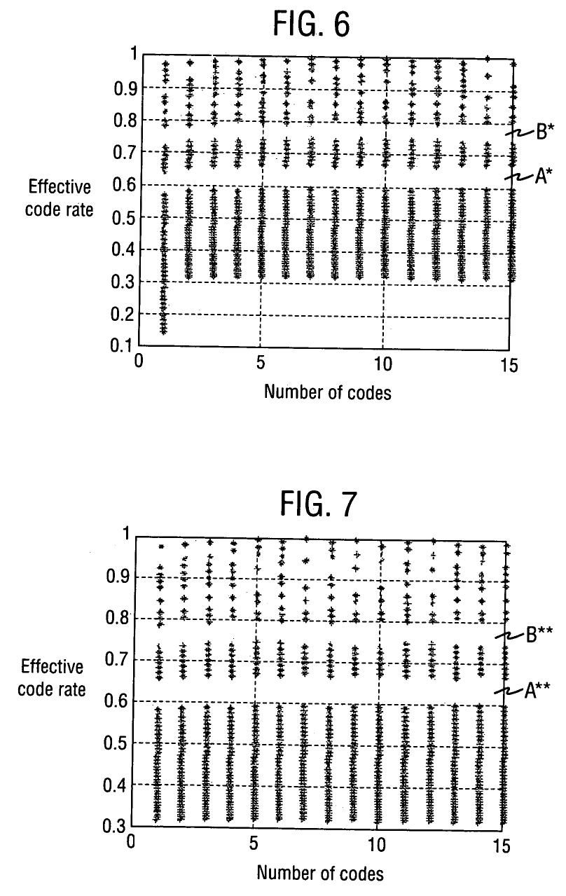

Reference is made to FIG. 6 which shows the effective code rate as a function of the number of physical channels allocated for transmission. As can be seen from the gaps marked A* and B* the problematic codes are eliminated. This is for QPSK.

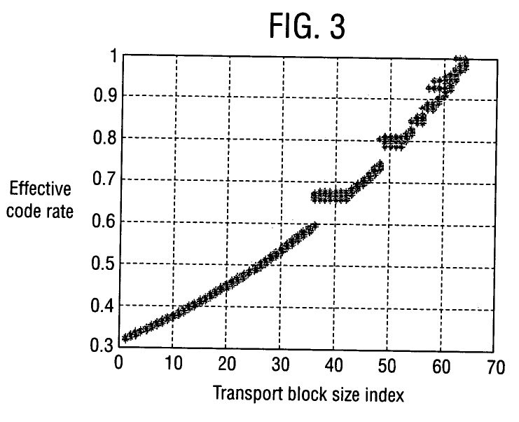

Reference is now made to FIG. 3 which shows a similar plot to that shown in FIG. 2 but for 16-QAM. Again, this has discontinuities where the problematic regions around 0.62 and 0.75 are avoided by using slightly higher effective code rates.

Reference is made to FIG. 7 which shows the effective code rate as a function of the number of physical channels allocated for transmission. As can be seen from the gaps marked A** and B** the problematic codes are eliminated. This is for QAM.

In order to implement embodiments of the present invention, algorithms on this base transceiver station will have already calculated which transport block size index to use. If the modulation scheme is QPSK, then table 1 is used whilst if 16-QAM is the modulation technique used, then table 2 is used. The tables are used to identify the new index to be used to make sure that no dangerous values are used.

CONSIDER TABLE 1

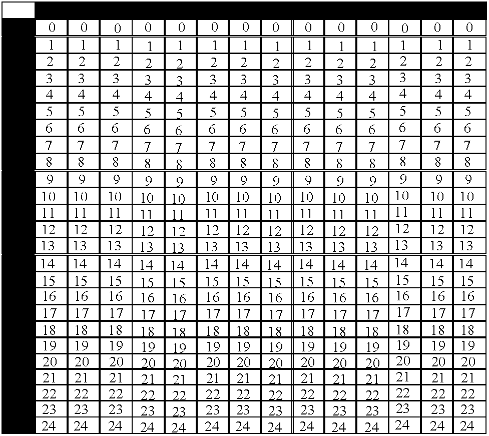

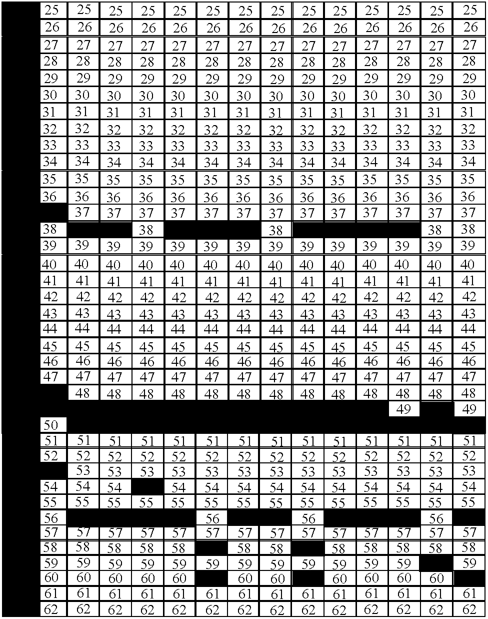

The values at the top of the column denotes the number of physical channels or multicodes used for communication with a given user equipment. The values going down the rows indicate the original estimated transport size to be used. To use the table, the column which includes the number of physical channels used is selected. The index which is originally estimated is then selected from the row. The new value included in the table is then used. Consider this example. Five codes are to be used and the estimated signal number is 49. However, as indicated in the table, this value is in a dangerous region and instead the index 51 is used. This will require more zero padding of the MAC-PDU but the significant increase in Es/NO (requirements is avoided.

The table, table 2, for the 16-QAM modulation scheme is used in exactly the same way.

TABLE 2

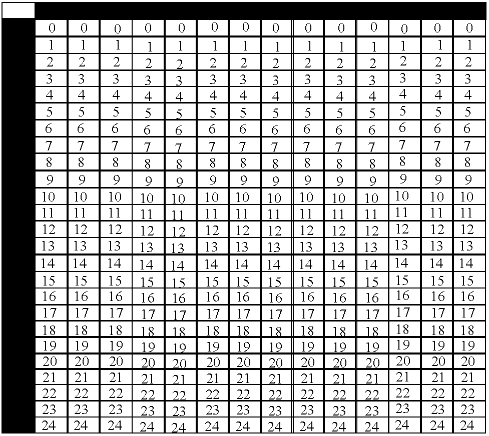

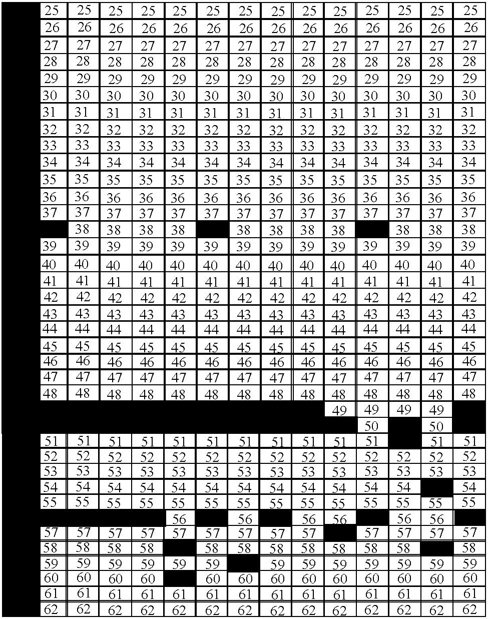

In embodiments of the present invention scheduling is done at the desired data rate but the transport block size is adjusted slightly such that the probability of success is significantly higher.

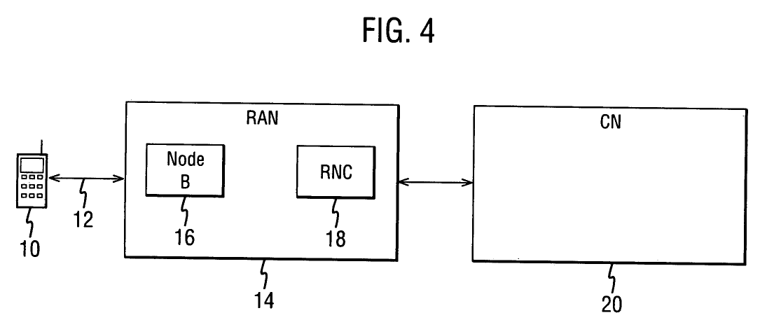

Reference is made to FIG. 4 which shows a system which embodiments of the present invention can be incorporated. User equipment UE 10 is arranged to communicate via an air or radio interface 12 with a radio access network RAN 14. The radio access network 14 comprises a plurality of base transceiver stations 16 (sometimes referred to Node-B), of which one is shown in FIG. 4. The radio interface is between the user equipment 10 and the base transceiver station 16. A plurality of base transceiver stations are controlled by a radio network controller 18. In practice, more than one radio network controller may be provided in a RAN 14. The RAN 14 is connected to a core network 20.

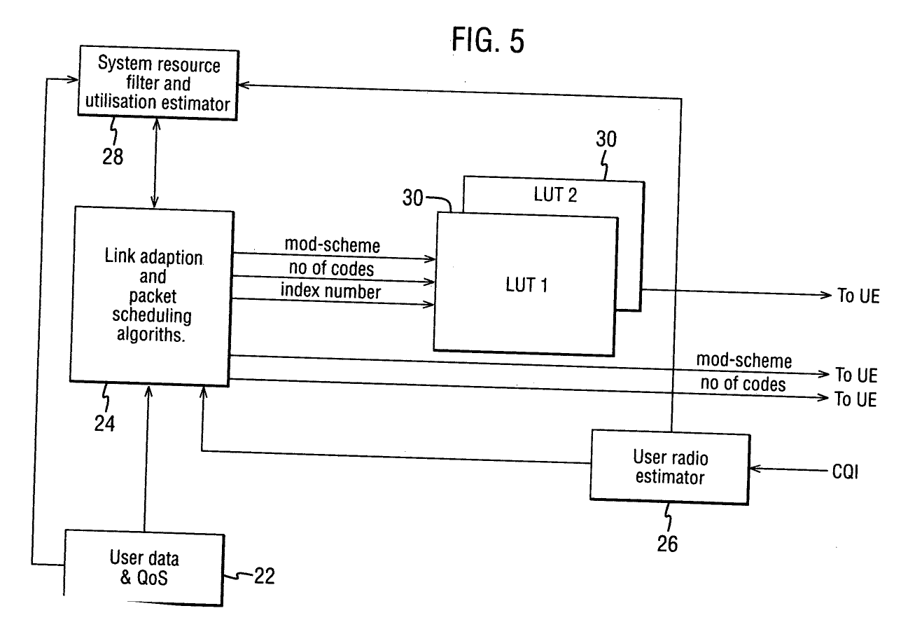

FIG. 5 is a schematic diagram of circuitry at the base station for implementing one embodiment of the present invention. The base station has a buffer 22 which receives user data along with quality of service QoS settings such as maximum delays, scheduling priorities, guaranteed throughputs or equivalent from the RNC.

The link adaptation and packet scheduling algorithm unit 24 receives the user data and quality of service settings from the buffer block 22 and implements packet scheduling and link adaptation algorithms for transmitting packet data to the user equipment. To aid the packet scheduling and link adaption, the unit 24 may receive radio channel quality estimates from an estimator 26 which receives information from each user equipment on an uplink path such as CQI (channel quality information).

In addition, the unit 24 may receive information about the allocated system resources from an utilisation estimator and system resource filter 28. The estimator and filter 28 receive resource allocation information from the radio network controller and may also receive data and quality of service settings from the buffer 22, radio channel estimates from the estimator 26 and scheduling information for data which is transferred from the unit 24. This information is used to carry out functions which assist with the evening out of power distribution for high speed transmission.

In embodiments of the present invention, the algorithms carried out by the link adaptation and packet scheduling algorithms 24 are known. The output provided by this unit 22 provide the index number, the number of codes and the modulation scheme. The modulation scheme and UE capability class will define which look up table 30 is accessed, the number of codes will define the column of the table to be looked at whilst the index number will define the row to be looked at. If the index number needs to be modified, then the output to the user equipment will include the modified index number. It should be appreciated that the user equipment is also sent the modulation scheme information and the number of codes.

It should be appreciated that embodiments of the present invention, the look up table can be replaced by a suitable algorithm.

The rows and columns of the table can of course be reversed. Embodiments of the present invention have been described in the context of a HSDPA system. However it should be appreciated that embodiments of the present invention can have wider application and can be used in any transmission system, wired or wireless. Embodiments of the present invention are particularly applicable to packet based transmissions but can also be used for non packet based systems.

Embodiments of the invention have described the base station as carrying out the determination of the transport block size. However in alternative embodiments of the invention a different entity may be used to determine the block size. It should be appreciated that the determination of block size and code rate may be distributed among a plurality of entities.

In preferred embodiments of the present invention, the transport block size is altered and the desired data rate is kept the same. The size of the transport block size is altered such that the probability of success in terms of lower Es/NO requirements is significantly higher. However in alternative embodiments of the present invention, the desired data rate is also adjusted.

It should be appreciated that embodiments of the present invention may be provided as a computer program element or as a computer program medium which can be used to control node B or the like.

It should be appreciated that although embodiments of the invention have been described in the context of third generation systems, embodiments of the present invention may also be used in for example the proposed fourth generation systems.

1. A method for determining a transport block size for use in a transmission of data comprising the steps of:
determining a desired code rate for transmission of data; and
adjusting a transport block size if the desired code rate is associated with a reduced performance.

2. A method as claimed in claim 1, wherein said adjusting step further comprises using at least one look up table.

3. A method as claimed in claim 2, further comprising at least one modulation scheme wherein a corresponding look up table of the at least one lookup table is provided for each of the plurality of different modulation schemes.

4. A method as claimed in claim 2, wherein said adjusting step further comprises selecting a look up table based on user equipment capability.

5. A method as claimed in claim 1, wherein said adjusting step further comprises using an algorithm.

6. A method as claimed in claim 1, wherein said adjusting step further comprises using information identifying at least one of modulation scheme, number of codes and index number of code.

7. A method as claimed in claim 1, wherein the adjusting the transport block size step improves the probability of receiving said data.

8. A method as claimed in claim 1, wherein said adjusted transport block size results in the code rate being higher than the desired code rate.

9. A method as claimed in claim 1, wherein said data comprises packet data.

10. A method as claimed in claim 1, wherein said transmission of data is in accordance with a High Speed Downlink Packet Access protocol.

11. A method as claimed in claim 1, further comprising a step of modulating said data in accordance with one of Quadrature Phase Shift Keying and Quadrature Amplitude Modulation.

12. A method as claimed in claim 1, comprising the step of sending at least one of an adjusted transport block size, number of codes information and modulation scheme information to user equipment.

13. A method as claimed in claim 1, wherein if the code rate is at least one of around 0.62 and around 0.75 the code rate is not the desired code rate.

14. An apparatus for determining a transport block size for use in a transmission data comprising:
means for determining a desired code rate for transmission of data; and
means for adjusting a transport block size if the desired code rate results in a reduced performance.

15. An apparatus as claimed in claim 14, wherein said apparatus comprises a node B.

16. An apparatus as claimed in claim 14, wherein said adjusting means comprises at least one look up table.

17. An apparatus as claimed in claim 16, further comprising at least one modulation scheme wherein a corresponding look up table of the at least one lookup table is provided for each different modulation scheme used by said apparatus.

18. An apparatus as claimed in claim 16, wherein said adjusting means is configured to select a look up table based on user equipment capability.

19. An apparatus as claimed in claim 14, wherein said adjusting means comprises an algorithm.

20. An apparatus as claimed in claim 14, wherein said adjusting means is arranged to use information identifying at least one of modulation scheme, number of codes and index number of said code.

21. An apparatus as claimed in claim 14, wherein the adjusting means is configured such that the probability of receiving said data is improved.

22. An apparatus as claimed in claim 14, wherein said means for adjusting is configured to adjust the transport block size such that the resulting code rate is higher than the desired code rate.

23. An apparatus as claimed in claim 14, wherein said transmission of data comprises packet data.

24. An apparatus as claimed in claim 14, wherein said transmission of data is in accordance with a High Speed Downlink Packet Access protocol.

25. An apparatus as claimed in claims 14, wherein modulation of said data is in accordance with either one of Quadrature Phase Shift Keying and Quadrature Amplitude Modulation.

26. An apparatus as claimed in claim 14, configured to send at least one of an adjusted transport block size, a number of codes information and modulation scheme information, to user equipment.

27. An apparatus as claimed in claims 14, wherein if the code rate is at least one of around 0.62 and around 0.75 the code rate is not the desired code rate.

28. Apparatus for determining a transport block size for use in a data transmission comprising:
circuitry configured to determine a desired code rate for transmission of data; and
at least one look up table for adjusting a transport block size if the desired code rate resulted in a reduced performance.

29. A computer program embodied on a computer-readable medium, wherein said computer program is configured to execute a procedure to determine a desired code rate for transmission of data and to adjust the transport block size if the desired code rate results in a reduced performance.

30. A computer program element comprising program code means, wherein said program code means is to make a computer execute procedure to determine a desired code rate for transmission of data and to adjust the transport block size if the desired code rate results in a reduced performance.
